(19) United States
(12) Patent Application Publication
(10) Pub. No.: US 2012/0303438 A1
(43) Pub. Date: Nov. 29, 2012

(54) POST PAID COUPONS

(75) Inventors: JOE FUTTY, Sammamish, WA (US); FERNANDO ZANDONA, Sammamish, WA (US); ERIC VANDENBERG, Redmond, WA (US); PETER MANSOUR, Kirkland, WA (US); G. ERIC ENGSTROM, Kirkland, WA (US)

(73) Assignee: MICROSOFT CORPORATION, Redmond, WA (US)

(21) Appl. No.: 13/113,457

(22) Filed: May 23, 2011

(51) Int. Cl. G06Q 30/00

(52) U.S. Cl. 705/14.34

(57) ABSTRACT

Systems and methods are provided for implementing coupons in conjunction with payment transactions involving electronic payment instruments. The benefit of the coupons can be provided to a customer after confirmation that the customer has satisfied all conditions of the coupon, which can include conditions on the type of good(s) and/or service(s) purchased as well as non-payment activities by the customer. If a coupon includes a non-payment activity condition, the non-payment activity can be performed either before or after the payment transaction(s) corresponding to the coupon.

### BACKGROUND

Providing an incentive for a customer to purchase a good or service is a common business strategy. Conventionally, coupons can be distributed to consumers by a variety of methods, such as direct mail distribution or as an advertisement in a newspaper. More recently, the general availability of personal computing resources has made other forms of coupon delivery possible, such as delivery to an e-mail address or a mobile phone. However, these electronically delivered coupons can still require a customer to redeem the coupon in a conventional manner, such as by presenting the coupon to the merchant at the time of purchase.

### SUMMARY

In various embodiments, systems and methods are provided for implementing coupons for use with payment transaction involving electronic payment instruments. The benefit of the coupons can be provided to the customer after confirmation that the customer has satisfied all conditions of the coupon, which can include conditions on the type of good(s) and/or service(s) purchased as well as non-payment activities by the customer. If a coupon includes a non-payment activity related condition, the non-payment activity can be performed either before or after the payment transaction(s) corresponding to the coupon. The benefit of a coupon can be provided to a customer based on a single payment transaction with a merchant, multiple transactions with a merchant, multiple transactions with multiple merchants, multiple transactions performed using multiple electronic payment instruments, or a combination of any of the above.

This Summary is provided to introduce a selection of concepts in a simplified form that are further described below in the Detailed Description. This Summary is not intended to identify key features or essential features of the claimed subject matter, nor is it intended to be used as an aid, in isolation, in determining the scope of the claimed subject matter.

### BRIEF DESCRIPTION OF THE DRAWINGS

The invention is described in detail below with reference to the attached drawing figures, wherein:

FIG. 1 shows a sample process flow according to an embodiment of the invention.

FIG. 2 shows additional sample process flows according to an embodiment of the invention.

FIGS. 3-5 show examples of methods according to various embodiments of the invention.

FIG. 6 is a block diagram of an exemplary computing environment suitable for use in implementing embodiments of the present invention.

FIG. 7 schematically shows a network environment suitable for performing embodiments of the invention.

### DETAILED DESCRIPTION

### Overview

In various embodiments, systems and methods are provided that can allow for post paid coupons. Post paid coupons refer to coupons where a customer does not receive the benefit of the coupon at the point of sale, but instead receives the benefit of the coupon at a later time based on confirmation that the conditions of the coupon have been satisfied. The conditions of a coupon can include both payment transaction requirements (such as buying a minimum dollar value of goods) as well as non-payment activity requirements (such as submitting a review of the merchant to a website). Whether the conditions of a coupon have been satisfied can be determined by reviewing information from various listings, such as a database of payment transactions between merchants and customers or a logfile of customer interactions with a web page. After detecting that the conditions for a coupon have been satisfied, the benefit of the coupon can be provided to the customer via a registered electronic payment instrument.

Conventional coupons can be an inefficient method of advertising for a merchant. Some of the inefficiencies can relate to the logistics of handling a transaction involving a coupon. First, a customer may be required to prove possession of a coupon at the point of sale in order to gain the benefit of the coupon. This poses a barrier for the customer, as the customer may be discouraged from conducting a transaction with a merchant if the coupon is lost or simply left at home when the customer visits the merchant's store. A conventional coupon can also be inconvenient for a merchant. The merchant may need to verify that the coupon is applicable to a given transaction with the customer.

Many of the inconvenient features of a coupon can relate to an attempt to provide the benefit of the coupon at the time of sale. One method for overcoming this difficulty can be to provide a post-purchase “rebate” to a customer. In a rebate scheme, a customer receives one or more items as part of a purchase transaction and/or the customer receives one or more documents that are generated as a result of the purchase transaction. While a rebate system can remove some of the inconvenience for a merchant, there is typically a corresponding increase in the inconvenience for the customer. For example, when a customer purchases a device, the device can include items such as a product model number, a serial number, or other information that is accessible when the device is turned on. The box containing the device can contain items such as codes, products numbers, a warranty card, or other items that tend to demonstrate purchase of the item by the customer. During the purchase transaction, the customer can further receive a receipt, a proof-of-purchase document, or other documents that indicate that a purchase transaction has been performed. In a rebate situation, the customer receives a rebate by providing one or more of these items or documents related to the purchase transaction to another party, such as the merchant or an original manufacturer. Providing these items may involve multiple steps, such as submitting a first set of information to a web site, printing out a document showing the printed information, and then faxing the printed document to manufacturer with additional items or information from the transaction, such as the date of purchase and the purchase price. In this document, all of the above rebate activity is defined as activity related to the initial purchase transaction, as all of this activity is related to submitting to the merchant, manufacturer, or another party items or information derived from the purchase transaction.

In addition to inconvenience, conventional coupons (or rebate schemes) can also have the disadvantage of not being aligned with the advertising goals of a merchant. Conventional coupons are typically focused on providing a cash incentive related to purchase of goods or services in a single transaction. If a merchant has a desire to increase the number of repeat visits by a customer, or to increase visits by new customers, or to increase word-of-mouth recommendations from existing customers to new customers, it can be difficult to incentivize this behavior using a conventional coupon.

In various embodiments, post paid coupons can provide a beneficial alternative to a conventional coupon. One advantage can be that the payment transaction (i.e., purchase) conditions of a coupon can be separated from the non-payment activities for the coupon. In some embodiments, when a customer is ready to buy a good or service that matches a condition of a coupon, the customer can immediately purchase the good or service without concern about having met other coupon conditions. Instead, the customer can satisfy the other coupon conditions after the time of purchase, and then receive the benefit of the coupon after meeting the other conditions. This can reduce or eliminate lost business for a merchant due to a customer losing a coupon or having uncertainty about coupon conditions.

Another advantage of post paid coupons can be that a merchant can more easily construct a coupon that involves multiple payment transactions with the merchant and/or involves payment transactions with multiple merchants. For example, three merchants in geographic proximity can set up a coupon that provides a benefit when a customer spends a minimum amount at each merchant. Because the benefit of the coupon can be delivered at a later time, the merchants do not have to verify customer activity at the other participating merchants. Instead, the benefit of the coupon is delivered to the customer automatically after transactions satisfying the coupon are completed at each merchant.

In describing the various embodiments, the terms “merchant” and “customer” are referred to. The terms are used only to indicate the relationship of parties in a transaction. A merchant is a party that is selling a good or service. In a payment transaction, a merchant is the party receiving payment. A customer is a party that is purchasing a good or service. In a payment transaction, a customer is a party that is providing a payment. It is conceivable that for some coupons involving multiple payment transactions as conditions, a single party could be characterized as both a “merchant” and a “customer”.

### Registration of Merchants and Customers

An initial activity for implementation of post paid coupons can be registration of merchants and/or customers in a system for managing the post paid coupons. One aspect of registration can be to allow identification of a merchant or a customer. For a merchant, registration can allow a merchant to identify the locations where the merchant sells goods or services by receiving payment using an electronic payment instrument that can be registered. One type of location can be a physical location, such as a conventional retail store that has a street address or that is located in a shopping mall. Another type of location can be a virtual location, such as a web page shopping portal. Still another type of location can be a mobile vendor location. A mobile vendor location can be physical mobile location, such as a food truck, or a virtual mobile location, such as a small business that accepts an electronic payment instrument using a smartphone application. Of course, locations that incorporate combinations of the above features can also be registered. A merchant can register locations in any convenient manner. For example, a merchant can register only a single location, or a plurality of locations as individual locations, or a plurality of locations as a single group. For a merchant with multiple locations, the manner of registering the locations can be selected to facilitate the types of coupons the merchant is planning to offer.

For a customer, registration of a customer can include identifying an electronic payment instrument for use in conjunction with post paid coupons. In order to participate in post paid coupons, a customer can register one or more electronic payment instruments capable of use in an electronic payment transaction. Electronic payment instruments can include instruments that have a corresponding physical token, such as conventional credit cards, debit cards, gift cards, and other physical tokens encoded with information that can be scanned or swiped. Note that a check can potentially serve as an electronic payment instrument via scanning of the check. In such an embodiment, the paper version of a scanned check can represent a physical token of an electronic payment instrument. Electronic payment instruments that do not involve reading a physical object or token can also be used, such as credit card information entered into a web shopping portal without swiping or scanning of the corresponding card. Other types of virtual transactions can include transfers directly from a bank account or transactions involving a credit/debit/gift card type account that does not have a corresponding physical card. More generally, any electronic payment instrument can be used that can participate in an electronic payment transaction.

When a customer registers an electronic payment instrument, the electronic payment instrument can potentially be used for at least two purposes. First, payment transactions conducted using a registered electronic payment instrument can be detected for potential redemption of a post paid coupon. A customer can register as many electronic payment instruments as desired. When a customer engages in payment transactions eligible for coupon redemption, the customer can use any registered electronic payment instrument. For a coupon involving multiple purchases, the customer can choose to use a first registered electronic payment instrument for a first purchase and a second, different registered electronic payment instrument for another purchase.

Another use of a registered electronic payment instrument can be for receiving the benefit of a post paid coupon. When a customer is entitled to receive the benefit of a post paid coupon, the benefit of the coupon can be delivered to a registered electronic payment instrument. The customer can designate an electronic payment instrument to receive the benefits derived from any redeemed coupon, or the customer can designate that the benefit of a coupon can be delivered to the electronic payment instrument used for the transactions corresponding to the coupon. Any other convenient option for designating an electronic payment instrument for receiving coupon benefits could also be used.

In another aspect, registration of a merchant or customer can provide authorization to participate in a system for providing and redeeming post paid coupons. Registration can allow a merchant or customer to authorize a third party to receive transaction data regarding electronic payments to a merchant and/or from a customer. For example, many merchants contract with a third party to allow the merchant to process credit cards from customers as a form of payment. Registration by a merchant can allow the third party credit card processor to also use the payment transaction information for implementing post paid coupons. Alternatively, registration by a merchant can authorize the third party credit card processor to forward payment transaction information to a separate entity that implements the post paid coupon system. Similarly, registration of an electronic payment instrument by a customer can authorize use of the customer's electronic payment information for implementing post paid coupons and/or authorize forwarding of the payment transaction information to another entity for implementation of post paid coupons.

Still another aspect of registration can be agreement by a merchant or customer to participate in post paid coupons that involve more than two parties. For a merchant, as part of registration a merchant can agree to participate in coupons involving activities at multiple merchants. This could include, for example, a coupon having conditions for purchasing a good or service from more than one merchant and/or having conditions for non-payment activity that relates to more than one merchant. A customer could similarly agree to participate in coupons involving multiple customers, such as a coupon where multiple customers receive a coupon benefit when each of the multiple customers purchases the same item. Such a coupon might also require the multiple customers to identify each other in some manner, such as identifying the multiple customers as a group at a merchant web site.

### Coupon Creation, Testing, and Distribution

Implementation of a post paid coupon can be enabled when one or more merchants creates a coupon. After registration, a merchant can access a coupon creation system or module. The coupon creation system can be integrated with the overall post paid coupon administration system, or coupon creation and distribution can be handled by a third party vendor. For simplicity, the following discussion may refer to a single merchant creating a coupon. It is understood that multiple merchants can collaborate to create a coupon involving more than one merchant.

During coupon creation, a merchant can login or otherwise authenticate the merchant's identity at a self-service portal. The merchant can then setup one or more offer campaigns involving post paid coupons. The post paid coupons can include any convenient conditions that are compatible with the post paid coupon format. The options that can be set by a merchant can include, but are not limited to, start and end dates for the coupon, the type and/or number of good and/or services that are eligible under the coupon conditions, the number of separate payment transactions required, the type and number of any non-payment activities used as conditions for the coupon, and/or the amount of benefit provided to a customer upon satisfying the coupon conditions. Optionally, the options for an offer campaign can include other merchants that are involved and/or required for satisfying the coupon conditions. The options can also specify a number of customers required for satisfying the coupon conditions, as well as the payment transactions and/or non-payment activities required from the multiple customers. For any of the conditions of the offer campaign, a fixed value may be used or a value can vary based on other factors. For example, the value of the benefit received by a customer when a coupon is redeemed may be dependent on one or more other conditions, such as the amount of goods/services purchased, the number of visits the customer made to the merchant, or the number of additional customers that identify a first customer as a referral source. In this latter scenario, as more new customers identify a first customer as a referral source, the first customer can be entitled to an increasing discount over time. As a result, the first customer can continue to receive additional benefits from a coupon over time.

Still another option during coupon creation can be to allow customer input regarding how customer transactions/activities are applied to various coupons that are available. In a sense, prompting a user for how to apply transactions and/or non-payment activities to coupons can be a type of non-payment activity. Allowing a customer to designate how transactions are applied can avoid customer dissatisfaction when a transaction or activity can only be applied to one offer campaign. If a customer is attempting to satisfy conditions for a multiple transaction and/or multiple non-payment activity coupon, having the coupon system automatically apply a transaction or activity to a single event coupon could result in a customer receiving a different benefit than the benefit desired by the customer. Input from a customer to designate how transactions are applied can be received in any convenient manner, including but not limited to electronic receipt of input. For example, after completing one or more payment transactions and/or one or more non-payment activities, a user can access a web site to assign the transactions and/or activities to a coupon for redemption. The web site can be a merchant web site, a web site associated with the post paid coupon system, or a third party site. After authenticating the identity of the customer, the customer can be presented with the payment transactions and/or activities that are recognized by the post paid coupon system. The customer could be presented with a convenient format for assigning the transactions and/or activities to eligible coupons, such as by providing a drop down menu or a menu with selectable radio buttons. The customer can then submit the assignments so that the customer's transactions and/or activities will be associated with the coupon selected by the customer.

After creating coupons, an optional testing module can be provided to allow a merchant to determine how multiple offer campaigns will interact with each other. In particular, one option a merchant can set for a post paid coupon is whether transactions/activities can be used to satisfy the conditions of more than one coupon. The testing module can allow the merchant to set up hypothetical scenarios of customer payments/activities in order to test the interaction of coupons. This type of testing can allow a merchant to avoid giving out larger coupon benefits than desired. This type of testing can also allow a merchant to identify offer campaigns that may conflict in a manner that would lead to dissatisfied customers.

After creation of an offer campaign involving a post paid coupon, and any optional testing, potential customers can be informed about the offer campaign in any convenient manner. This can include posting the coupon conditions in the store of the merchant, posting the coupon conditions on a merchant web site, posting the coupon conditions on another web site as advertising, sending out e-mail advertising, sending out conventional television, direct mail, or print advertising, or any other convenient method. It is noted that in some embodiments, informing a customer of an offer campaign can be optional. In such embodiments, a customer can receive the benefit of a post paid coupon even though the customer was unaware that the conditions for the coupon were being satisfied by the customer's payment transactions and/or non-payment activities.

### Payment Transactions as Coupon Conditions

As an initial matter, a customer can typically satisfy a few minimum requirements to be eligible for a post paid coupon. These requirements could optionally be viewed as additional conditions related to a payment transaction. For example, a requirement can be that a customer has one or more electronic payment instrument(s) registered with a post paid coupon system, and that one of these registered electronic payment instrument(s) is used for purchase transactions that are eligible for post paid coupons. Another requirement can be that the electronic payment instrument is capable of receiving the benefit of a post paid coupon when the conditions of a coupon have been satisfied. Still another requirement can be that the customer is registered with the same post paid coupon system as the merchant and/or registered with a post paid coupon system that can interact with the post paid coupon system of the merchant.

In addition to the minimum requirements for redeeming a post paid coupon, one type of condition on a coupon can be a condition related to a payment transaction. Payment transaction requirements for a coupon can be any convenient combination of requirements related to transactions between one or more customers and one or more merchants. Of course, one type of condition for a payment transaction can be that a coupon can apply to any transaction between a registered merchant and a registered customer. Other examples can include conditions for a customer to buy a particular good or service offered by a merchant; to buy a specified dollar value of goods or services; to have a minimum number of purchase transactions with a merchant; or to have purchase transactions with a merchant on multiple different days. An example of a condition for buying a particular good or service can be a condition for buying a good with a particular stock keeping unit (SKU) number or another type of product code. This type of condition could also require that multiple items are purchased, such as multiples of a single item and/or more than one type of item. A specified dollar value of goods or services can provide a condition that provides an incentive for a customer to purchase more goods or services in a single transaction. A condition for performing multiple purchase/payment transactions with a merchant and/or transactions on multiple days can provide an incentive for a customer to engage in repeat business with a merchant. Optionally, a merchant could specify that use of a particular electronic payment instrument can provide a benefit (or an increased benefit) to the consumer.

Another type of a payment transaction condition can be a condition for purchases from multiple merchants. For example, a group of merchants in geographic proximity to each other may have complementary goods or services, such as a first store that sells carpet, a second store that sells drapes and blinds, and a third store that sells furniture. An offer campaign can be developed for a post paid coupon with a condition that a customer has a payment transaction with each of the three merchants. Another example could be two or more museums that would like to offer a discount to customers who visit the museums. Rather than requiring the customer to commit buying a package at the first museum, a post paid coupon can allow the customer to automatically receive the discount after purchasing admission to the second museum. While the above examples involve businesses with a geographic or business category relationship, such relationships are not required for offering a post paid coupon. Thus, seemingly unrelated businesses, possibly operating only with a web based shopping portal, could offer a post paid coupon with a condition of having a payment transaction at the location/shopping portal for each business.

Still another example of a payment transaction condition can be a condition that multiple customers have a payment transaction with one or more merchants. This type of condition may often be coupled with a non-payment activity so that the merchant can identify a the multiple customers as a group, as described below.

In any of the above examples, the payment transaction condition(s) for the coupon can optionally have more than one threshold level, so that a customer can receive a different benefit by meeting a different threshold level for a condition. For example, a customer can receive a first benefit if five items are purchased, and an additional benefit if twenty items are purchased. Additionally or alternately, a customer can receive an increasing benefit for each additional participating merchant with which a customer performs a payment transaction. Additionally or alternately, a “referral bonus” benefit for a first customer can increase for each additional customer that identifies the first customer as the source of referral.

### Non-Payment Activities as Coupon Conditions

In addition to payment transactions, an offer campaign can also have conditions related to non-payment activities. Non-payment activities can be activities by a customer that are not related to a payment transaction for a good or service. As an initial example to clarify the distinction between a payment transaction condition and a non-payment activity condition, consider a merchant that desires an increase in business at a particular store location. A payment transaction condition can be a condition where the payment transaction must occur at the identified store location. A non-payment activity condition can be that a customer separately registers the customer's presence at the store, such as via detection of a mobile device belonging to the customer using an RFID signal. A merchant could include one or both conditions as part of a post paid coupon in order to increase traffic at the identified store location. In various embodiments, a non-payment activity can also be unrelated to the good or service purchased using the payment transaction. In such embodiments, receipt of the good or service purchased during the payment transaction does not correspond to a non-payment activity. Additionally or alternately, in various embodiments, providing one or more items received during a purchase transaction (such as a product code or a warranty card) to another party does not correspond to a non-payment activity. Additionally or alternately, in various embodiments, providing one or more documents generated as a result of a purchase transaction (such as a receipt or a proof-of-purchase document) to another party does not correspond to a non-payment activity.

Non-payment activity can occur either before or after a payment transaction associated with a coupon. One example of a non-payment activity that may occur prior to a payment transaction can be having a customer “clip” or otherwise activate a coupon. In some embodiments, a merchant may wish to have a customer activate a coupon prior to allowing the customer to receive the benefit of the coupon. This activation can be a replacement for the conventional coupon redemption step of bringing a coupon to the merchant and presenting the coupon at the point of sale. It is noted that activation of a coupon can provide benefits to a customer, such as by providing an alarm (or other notification) on the customer's mobile device when the customer enters a location (i.e., store) that corresponds to an activated coupon. Depending on the embodiment, a coupon condition can require that a coupon is activated prior to completing any other condition for a coupon, or a coupon can require that a condition is satisfied at any time prior to a customer receiving the benefit of a coupon. Optionally, a coupon may not have activation as a condition. In this optional embodiment, a customer can receive the benefit of a coupon when the conditions of the coupon are met, regardless of whether the customer is aware of the coupon.

A customer can activate a coupon by any convenient method. Activation of a coupon can include selecting a coupon on the system associated with creation and/or distribution of the coupon. Another activation option can be to have the customer download the coupon to a mobile device and present the coupon to the merchant. (It is noted that if the condition requires the coupon to be presented to the merchant at the point of sale, activation of the coupon can be a payment transaction condition.) Still another option can be to require the customer to access a merchant web site and/or send an e-mail to the merchant to indicate a desire to use the coupon. The above options are merely examples of possible non-payment activities that could be used as methods for activating a coupon.

A variety of other types of non-payment activities can also be used as conditions for a coupon. Depending on the condition, the non-payment activity can occur at any time, or the non-payment activity can have a time relationship to the payment transaction(s) associated with a coupon. For example, a non-payment condition can require a user post a review of a product or service to a designated web site within a period of time after a payment transaction for the good or service. Optionally, a condition related to posting of a review could have a further requirement that the customer send a link to the review to the merchant, for ease of tracking that the non-payment condition has been satisfied. Still another option can be for the merchant to send a customer a survey after a purchase, with completion and/or return of the survey as a condition for the coupon.

Some types of non-payment activities can be related to a customer's presence at a physical or virtual location. As noted above, detecting a mobile device belonging to a customer at a store location can be a type of non-payment activity condition. Another type of non-payment activity can involve having a customer scan or otherwise obtain an image from a store location, such as a QR (quick response) code. The customer could then, for example, send an e-mail or upload the code to a merchant web site to verify that the customer has satisfied the non-payment condition. Note that having a customer scan or otherwise obtain an image can be used as part of a “scavenger hunt” type coupon, where a customer obtains images (such as QR codes) from multiple merchant stores, web sites, or other physical/virtual locations in order to satisfy a coupon non-payment activity condition. The multiple images can all be associated with a single merchant, or the multiple images can be associated with different merchants that are participating in a multiple merchant offer campaign. Additionally, a time component can be involved in the coupon condition, such as requiring that the images are obtained on different days.

Still other options for non-payment activity conditions can involve activity by a customer on one or more web sites, portals, or other locations accessed via a network. In addition to accessing a network site to authenticate a customer's identity, a customer can perform one or more additional tasks, such as completing a survey, providing a product review, view a web page or video for a predetermined period of time, or any other task suitable for completion via a computing device. With regard to verifying a customer's identity, any convenient method of identifying the customer can be used. For example, a customer could provide an e-mail address that was identified as part of the customer's registration with the post paid coupon system. Another option could be for the customer to provide a user identifier or other identification token or code that was provided to and/or selected by the customer when the customer registered. Yet another option can be to have the network activity occur at a network location that is accessed after the customer logs in to the post paid coupon system.

Yet other options for non-payment activity can involve activities by multiple consumers. For example, an offer campaign can provide a coupon benefit to a first customer that refers one or more additional customers to a merchant. The one or more additional customers can confirm the referral of the first customer in any convenient manner. This could involve providing information regarding the first customer when the one or more additional customers perform a payment transaction with the merchant. Alternatively, the one or more additional customers could complete on online form identifying the first customer. After receiving the referral information from the one or more additional customers, the first customer can receive the benefit of the post paid coupon at the designated electronic payment instrument.

A variant of the referral type coupon can be a “group purchase” type coupon. In a group purchase situation, a plurality of customers can inform a merchant of their group status in a manner designated by the merchant. This can involve accessing the merchant's web location and entering identifying information for each customer that will be part of the group. When two or more of the group members satisfy a payment transaction condition, such as each member buying the same item or buying a threshold amount of goods/services, the group members can receive the benefit of the coupon. In this example, the identification of the group of customers can correspond to a non-payment activity. In addition to identifying the group of customers, other non-payment activities can include having members of a group visit store locations, access web sites, or perform other activities suitable for use as coupon conditions.

Still another type of coupon condition can be a condition that is typically performed after a payment transaction. These types of non-payment activity conditions can include having customers provide reviews or complete surveys, as described above.

### Detecting Customer Completion of Coupon Conditions

In order to provide a customer with the benefit of a coupon, the payment transactions and/or non-payment activities of the customer can be detected. Detection of payment transactions can be performed by any convenient method. As an initial matter, in order to be eligible for the benefit of the coupon, the merchant and the customer involved in a transaction can be registered with a post paid coupon system. The customer registration can include registration of at least one electronic payment instrument. This registration can authorize the post paid coupon system to receive information regarding payment transactions between a registered merchant and a registered customer.

The following is a non-limiting example of detecting a payment transaction. Based on the registration of the merchant with a post paid coupon system, all listing of transactions involving the merchant can be scanned or filtered to select transaction that use a potentially eligible electronic payment instrument. This scan can be performed by a suitable party, such as a company hired by the merchant to handle processing of credit card transactions. Alternatively, the scanning can be performed by the post paid coupon system. The listing can correspond to a logfile, a database, or any other convenient data store that contains information regarding payment transactions. Any scanned transactions that also involve a registered customer, and that are performed using an electronic payment instrument associated with that registered customer, can be extracted. These extracted transactions can represent payment transactions that potentially satisfy one or more coupon conditions. The extracted payment transactions can then be compared with coupons that were active on the date of the transaction. If a payment transaction satisfies a condition for at least one coupon, the payment transaction can be considered as a matching transaction. Optionally, the payment transaction can be automatically associated with each coupon that has a condition resulting in a match. Alternatively, if at least one coupon has a condition that prevents a transaction from being associated with multiple coupons, a priority algorithm can be used to identify a coupon for association with the payment transaction. Still another option can be to provide a customer with a list of payment transactions and a list of potentially matching coupons for association based on input from the customer.

Optionally, matching of a payment transaction with a coupon condition can require additional information from a merchant. For example, a payment transaction condition related to purchasing a good having a specified SKU or product number may need additional merchant information. A credit card transaction purchasing a good or service may not include an identifier such as an SKU. Thus, a merchant may provide a separate logfile or other database that identifies transactions performed by a merchant and associates additional information with the transaction.

Non-payment activities can be processed in a manner similar to payment transactions. As an initial matter to allow for processing, a listing such as a logfile or database containing non-payment activity information can be created. The listing of non-payment activities can be created and maintained by a merchant, by the post paid coupon system, or by another party. The non-payment activities can be captured in the listing by any convenient method that is appropriate to the type of activity. For example, a non-payment activity requiring detection of a customer's mobile device at a store location can be captured by a merchant computing device and recorded in a logfile. Alternatively, any non-payment activity that involves accessing a web site or portal can be logged and captured by an appropriate system belonging to the merchant, post paid coupon system, or another party.

A non-payment activity listing can be scanned to identify activities that match coupon conditions, as described above for payment transactions. At a minimum, a non-payment activity listing can include an identifier for a customer and some indication of the non-payment activity that has been completed. Based on this information, non-payment activities can be matched with coupon conditions.

Matching of payment transactions and/or non-payment activities with coupon conditions can occur at any convenient time. Matching of transactions and/or activities with coupons can be performed by any convenient entity, such as the merchant or by the post paid coupon system. One option can be to match payment transactions and/or non-payment activities on a daily basis. For example, a listing can be generated on a daily basis of payment transactions for a merchant that potentially match a coupon condition. A listing can also be generated of non-payment activities that potentially match a coupon condition. These listings can be used to associate transactions and/or activities with coupons. Additionally or alternately, potentially matching transactions and/or activities can be stored, such as on a per customer basis. This can allow for customer association of transactions and/or activities with coupons. This can also allow for transactions and/or activities to be applied at a later time to a coupon, such as a coupon that a customer has not activated yet or possibly even a coupon that a merchant creates at a later time but that has a condition that can be satisfied by a past transaction or activity. Stored transactions and/or activities can be kept for any convenient period of time, such as for a period of days, a period of weeks, or a period of months.

### Billing Merchant and Providing Customer Benefit of a Coupon

Based on a determination that a customer has satisfied all of the conditions of a coupon, the benefit of the coupon can be provided to the customer. This can be achieved, for example, by crediting an electronic payment instrument designated by the customer during registration with the post paid coupon system. The benefit to the customer can include a credit to the customer balance on the registered electronic payment instrument. Additionally or alternately, the benefit to the customer can include other features, such as reward or loyalty points associated with the electronic payment instrument and/or associated with the post paid coupon system, so long as such points can be considered as “delivered” to the electronic payment instrument designated by the customer based on satisfying the conditions of a coupon.

In addition to providing the benefit to a customer, a merchant can also be billed for the value of the coupon, plus an optional processing fee and/or an advertising action fee. The billing of the merchant can optionally be aggregated to allow for billing on a convenient schedule, such as once a month. Alternatively, a merchant can provide funds for an offer campaign to a post paid coupon system in advance, and the benefits to the customer can be deducted from the advance funds on a rolling basis.

### Example 1

### Post Paid Coupon for Multiple Merchants

In this example, Able, Inc., the Baker Business, and Charles Corp. have a desire to collaborate in a marketing campaign. Able, Baker, and Charles register as merchants with system for post paid coupon management. The merchants approve an offer campaign with the following conditions: a customer must perform a payment transaction with each merchant within a defined time period (in this example, 30 days); the combined value of the payment transactions with the merchants during the defined time period must be greater than $100; and the customer must access a web site associated with each of the merchants, where the URLs for the required merchant web locations can be obtained by scanning or acquiring an image of a QR code from each merchant. The customer's identity can be verified by having the customer enter an e-mail address or a user identifier from the post paid coupon system at the web site corresponding to each of the URL's. Alternatively, the customer can first log in to the post paid coupon system and then visit the web locations. The QR codes can be posted at various locations in each merchant's store. No activation of the coupon is required. When all conditions are satisfied, the customer will receive a 10% rebate on the total value of all qualifying purchases during the defined time period. After setting up the offer campaign, Able, Baker, and Charles provide a description of the coupon on their individual web sites. Able, Baker, and Charles also send a notice of the coupon to prior customers of any one of the merchants based on previous collection of e-mail addresses. After setting up the offer campaign, each business displays the QR code associated with their business in prominent locations around the store.

Potential customer Pete visits Able, Baker, and Charles on the fifth day of the coupon period. Pete makes a purchase at each store. The combined purchases total more than $100. Pete uses a registered electronic payment instrument (a debit card) for each of the purchases. Pete observes the QR codes in each store, but he does not pause long enough to read the accompanying coupon description. Pete has previously registered with the post paid coupon management company. After the close of business, a scan of the merchant transactions identifies Pete's transactions with each of Able, Baker, and Charles. The transactions are matched with the coupon conditions. However, no payment is credited to Pete's debit card, as Pete has not satisfied the non-payment activity condition. Instead, Pete's matching transactions are stored, in the event that Pete completes the non-payment activity conditions for the coupon at a later time within the 30 day time period associated with the coupon.

Pete's friend Paul is also registered with the post paid coupon system. The next day, Paul visits Able, Baker, and Charles in order. Paul makes a $10 purchase at each merchant using a registered electronic payment instrument (a credit card). Paul also sees the QR codes at each store. Because Paul is in a hurry, he does not stop to ask about the ad campaign. However, because Paul knows that QR codes are used for post paid coupons, Paul captures the QR codes at each merchant. After Paul gets home, he logs into the post paid coupon system and finds the Able-Baker-Charles offer campaign. Based on the description, Paul visits the web locations associated with each of the QR codes. Because Paul visits the web locations while logged in to the post paid coupon system, Paul's identity for the non-payment activity is automatically authenticated. Paul also registers a gift card for Baker Business on the post paid coupon system. The next day, Paul returns to Baker and purchases another 75$ of goods from Baker using the newly registered gift card. After this purchase, the next daily scan of transactions identifies that Paul has satisfied all payment transaction conditions for the coupon. The post paid coupon system also receives the logfile from Charles that demonstrates that Paul has satisfied the non-payment condition for the coupon. The next day, Paul receives a credit of $10.50 to his debit card. Able and Charles are billed $1 each, while Baker is billed $8.50. Optionally, a handling fee can also be charged to each merchant, or the post paid coupon service can be provided for a flat fee regardless of transaction amount.

The day before the end of the defined time period, Paul informs Pete of the ad campaign. Pete returns to each of Abel, Baker, and Charles and captures the QR images. Pete then accesses the web locations provided in the QR codes, along with Pete's user identifier from the post paid coupon system. That night, the logfiles from the Able web site are uploaded and processed. The match between Pete's non-payment activity and the coupon is identified. The next day, Pete receives his 10% rebate and the merchants are billed accordingly.

### Example 2

### Post Paid Coupon for Multiple Customers

Zelda Corp is a new online business. In order to gain word-of-mouth traffic, Zelda registers with a post paid coupon system. Zelda then sets up an offer campaign for a post paid coupon. The payment conditions for the coupon require that payment transactions must occur after activation of the coupon by a customer. Additionally, at least five members of a group must engage in a payment transaction after appropriate activation. The coupon otherwise applies to any payment transaction with Zelda, which could optionally be viewed as a payment transaction condition of “any payment transaction.” For non-payment activity conditions, the coupon requires a customer activate the coupon by providing a group identification token prior to completing the purchase transaction. The group identification token must correspond to a group having at least five members, and up to 20 members. A customer can obtain a group identification token by joining a group at the post paid coupon system. Joining a group requires knowing the password for the group. The benefit of the coupon is that when at least 5 members of the group have met the coupon conditions, each group member receives a discount corresponding to the number of group members that have met the conditions.

Potential customer George sees the offer campaign for Zelda in a web advertisement. George is registered with the post paid coupon system. George goes to the Zelda web site and purchases a service using a registered electronic payment instrument. George then invites four friends to form a group on the post paid coupon system. George and the four friends receive a group identification token. After forming the group, each of the four friends purchases a service from Zelda and provides the group identification token prior to completing the payment transaction. For example, a field can be available on one of the payment information screens for entering the group identification token. The merchant reports this coupon activation information to the post paid coupon system after close of business each day in the form of an activity logfile (a listing). During the scan of payment transaction and non-payment activity logfiles, the activation of the coupon by the four friends is detected. The payment transactions of the four friends are then identified and matched with the coupon. However, because George did not activate the coupon prior to his payment transaction, no benefits from the coupon are distributed at this time.

A few days later, the four friends provide the group password to Ned, an additional potential customer. Ned uses the group password to add himself to the group. Ned then performs a payment transaction with Zelda, and provides the group identification token prior to completing the transaction. That night, Ned's non-payment activity and payment transaction are detected. Because the conditions for the coupon have now been satisfied, an amount corresponding to 5% of the purchase price is then returned to Ned and the four friends. George still does not receive a discount.

The next day, George engages in second purchase with Zelda. George enters the group identification token prior to completing the second transaction. After scanning of logfiles, Georges completion of the conditions for the coupon is detected. George receives a 6% discount on only the second transaction, as the first transaction does not meet the coupon conditions. The other members of the group also receive an additional 1% rebate, as there are now six members of the group that have satisfied the conditions of the coupon.

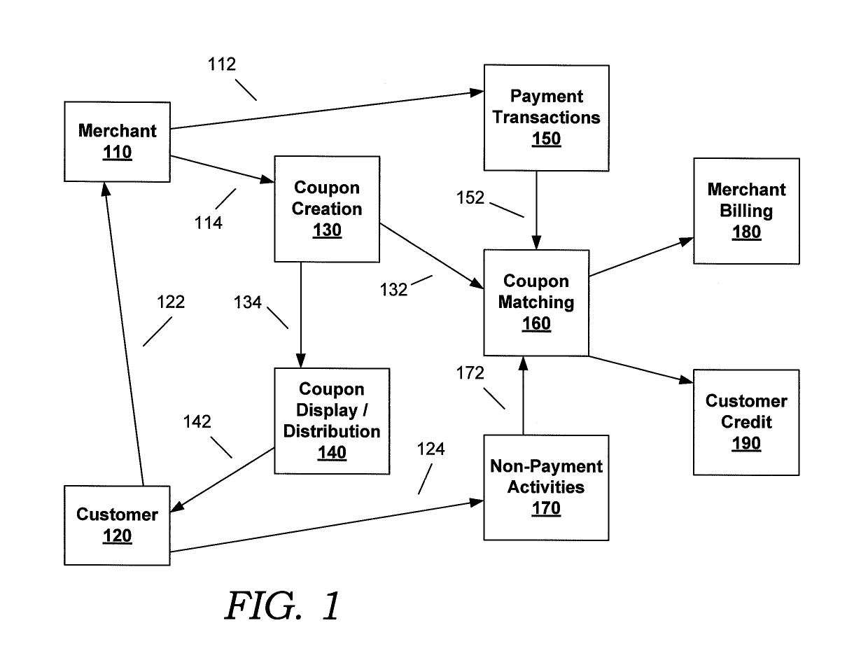

FIG. 1 shows an example of a potential process flow for implementing post paid coupons. In FIG. 1, a merchant 110 starts the process by creating a coupon or offer campaign 114 using a coupon creation system or application 130. After creation of a coupon, the coupon can be published 134 by a coupon display or distribution entity 140. Coupon display or distribution 140 can be performed, for example, by a web site that a customer can visit. Additionally or alternately, coupon display or distribution 140 can represent a service that distributes physical and/or virtual copies of a coupon. Optionally, a customer 120 may activate or “clip” a coupon 142 after seeing the coupon.

After the coupon is created 114, and optionally after the user has activated the coupon 142, the customer 120 can transact 122 with merchant 110, such as by buying a good or service. The customer 120 can provide payment for the transaction 122 using a registered electronic payment instrument. Payment transactions involving the merchant 112 can then be uploaded to a payment transaction database or log 150. Payment transaction database can represent, for example, a database operated by a provider of merchant credit card services. Alternatively, payment transaction database can represent the smaller group of transactions, such as transactions involving the merchant based on use of a registered electronic payment instrument by a registered customer. This type of smaller database can be operated, for example, by a credit card provider or by a post paid coupon system. In addition to transaction 122, customer 120 can also optionally engage in one or more non-payment activities 124. The completion of these non-payment activities 124 can be captured by non-payment activity database or logfile 170. It is noted that coupon activation 142 could represent a non-payment activity that is captured by non-payment activity logfile 170. Non-payment activity database or logfile 170 can be, for example, a logfile (or database) operated by a merchant, a database operated by a provider of merchant credit card services, a database operated by a post paid coupon system, or a database operated by another entity.

Based on the above activity, a coupon matching engine 160 can determine the eligibility of a customer 120 for a customer credit 190. The coupon matching engine 160 can receive information 132 regarding active coupons from coupon creation engine 130. This can occur as needed, such as on a periodic basis. Coupon matching engine 160 can also receive information 152 regarding payment transactions from payment transaction database 150, as well as information 172 regarding non-payment activities from non-payment activity database 170. Coupon matching engine 160 can then match the payment transaction information 152 and non-payment activity information 172 with coupon conditions to identify customers 120 that are eligible for a customer credit 190. When a match is detected, the merchant 110 can also be billed 180.

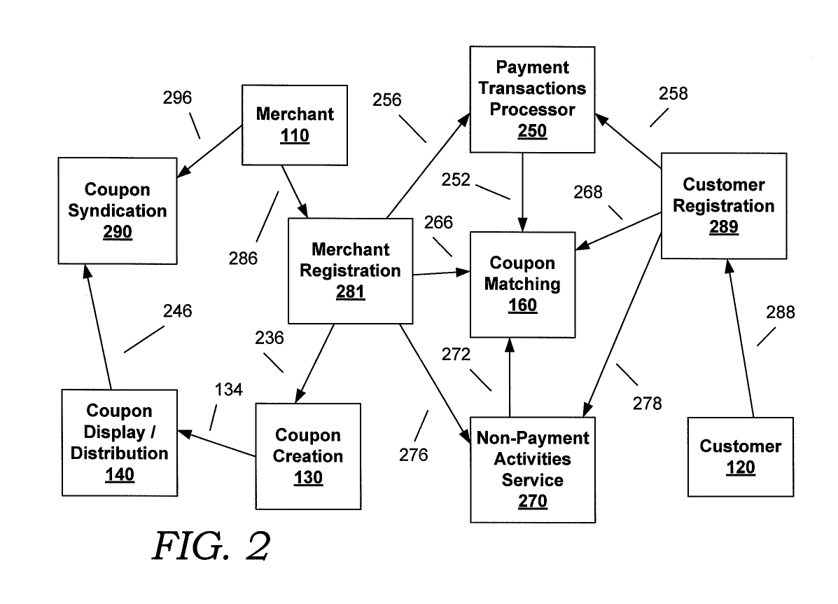

FIG. 2 schematically shows additional or supporting processes that may be involved in the creation and distribution of post paid coupons. In some embodiments, one or more of the processes or interactions shown in FIG. 2 can be optional and/or omitted.

Many of the processes and systems shown in FIG. 2 are related to registration of entities with different parts of a post paid coupon system. In FIG. 2, a merchant 110 can register 286 for post paid coupons using a merchant registration system 281. Although the merchant registration system 281 is shown in FIG. 2 as a distinct system, the functions of merchant registration system 281 can additionally or alternately be distributed across one or more other systems or modules that a merchant interacts with. For example, a merchant can register with a payment transactions processor 250. Payment transactions processor 250 can be a system or entity that maintains a payment transactions database, such as payment transactions database 150 shown in FIG. 1. Registration 256 by a merchant, optionally via merchant registration module 281, can allow the merchant to authorize the payment transactions processor 250 to aggregate payment transaction information from the merchant. The payment transaction information can be transferred 252 to a coupon matching engine 160. Merchant 110 can also optionally register 266 with coupon matching engine 160. This can be required, for example, if the payment transactions processor 250 is not part of the same entity as coupon matching engine 160. If multiple coupon matching engines are available, merchant registration could be used to authorize the transfer of information from payment transactions processor 250 to coupon matching engine 160. A merchant 110 can also optionally register with a non-payment activities aggregation service 270, which can represent a third party service to handle receipt and processing of non-payment activity information, such as non-payment activity log 170 from FIG. 1. The non-payment activity information can then be forwarded 272 to coupon matching engine 160. Yet another merchant registration activity can be registration 236 with a coupon creation system 130. Registration 236 can represent the same activity as registration with another component, such as registration 266 with coupon matching engine 160. Alternatively, registration 236 can be a separate activity.

A customer can also register with one or more systems or entities involved in a post paid coupon system. Optionally, customer registration 288 can be facilitated using a customer registration system 289, or a customer can register directly with one or more components. Customer registration activities can include registration 258 with the payment transactions processor 250. This registration can allow the payment transaction entity to aggregate information regarding customer transactions with registered merchants. It is noted that in some situations, the terms of use of an electronic payment instrument may implicitly provide for registration 258. Another registration activity can be registration 268 with a coupon matching engine 160. This registration can allow a customer to authorize one or more electronic payment instruments for use in performing transactions and/or receiving benefits under a post paid coupon program. Optionally, this registration might instead be provided to payment transactions processor 250. Registration 268 may also allow a customer to register any coupons that the customer desires to activate with coupon matching engine 160. Alternatively, activation of coupons can occur with another system or module involved in processing post paid coupons. A customer may also register 278 with a non-payment activities service 270. This registration can assist in allowing non-payment activities service 270 to match a customer's non-payment activities with corresponding payment transactions.

In addition to various registration activities, FIG. 2 also schematically shows some additional activities related to coupon distribution. When a merchant creates a coupon using coupon creation system 130, the coupon can be transferred 134 to coupon display and distribution system 140 for delivery to customers. One option for display and distribution of an electronic coupon is to syndicate 246 the distribution of the coupon using a coupon syndication service 290. A coupon syndication service 290 can be a service that allows a merchant's coupons to appear on web sites of third party entities that generate revenue by display advertisements. In order to authorize syndication 246, a merchant can optionally register 296 with a coupon syndication service 290. Although registration 296 is shown as occurring directly with coupon syndication service 290, the registration could alternatively be handled by merchant registration module 281.

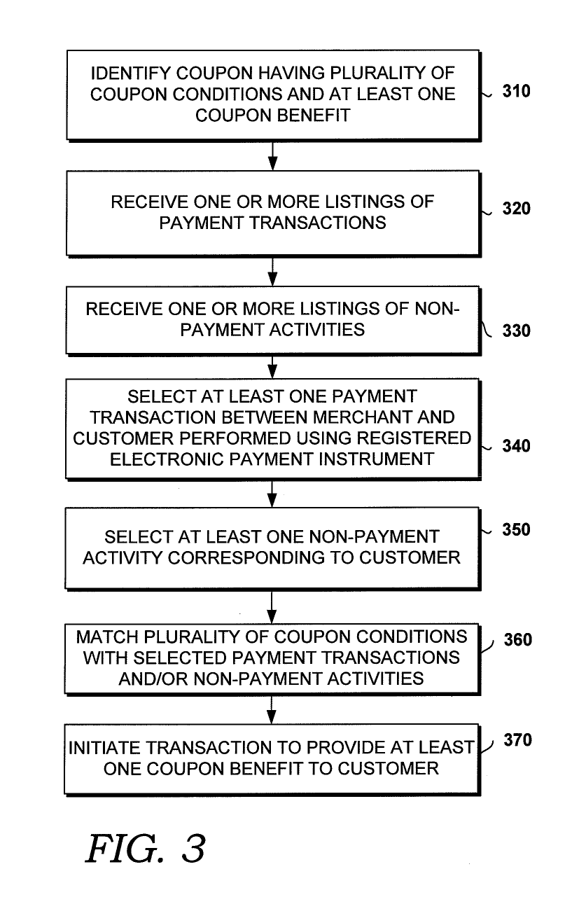

FIGS. 3-5 provide flow diagrams of methods according to various embodiments of the invention. FIG. 3 shows an embodiment related to a method for providing a benefit to a customer after conducting a payment transaction. In FIG. 3, a coupon can be identified 310 having a plurality of coupon conditions and at least one coupon benefit. One or more listings of payment transactions can be received 320. One or more listings of non-payment activities can also be received 330. At least one payment transaction between a merchant and a customer is selected 340. The selected payment transaction can be a payment transaction performed using a registered electronic payment instrument. At least one non-payment activity corresponding to the customer can also be selected 350. A plurality of coupon conditions can be matched 360 with one or more of the selected payment transactions and/or one or more non-payment activities. Based on the matching, a transaction can be initiated 370 to provide a coupon benefit to the customer.

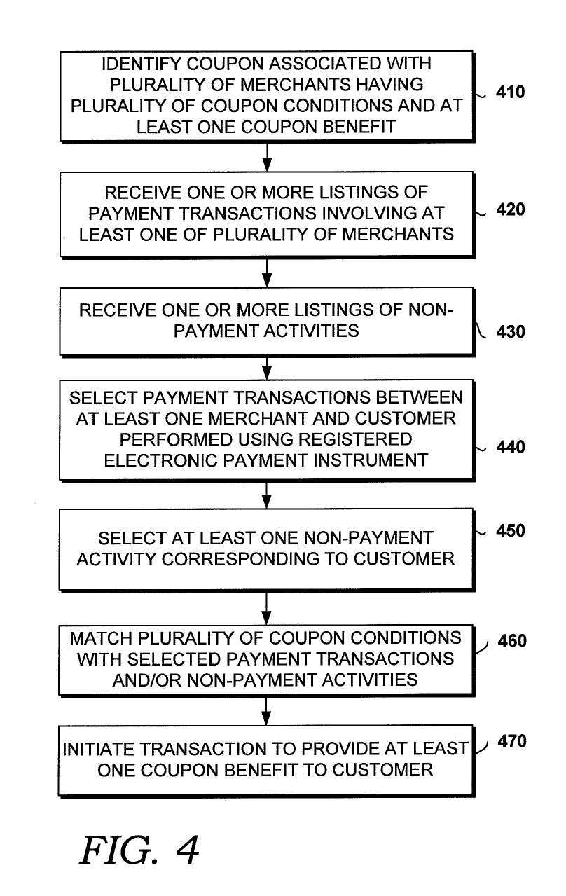

FIG. 4 shows another embodiment related to a method for providing a benefit to a customer after conducting a payment transaction. In FIG. 4, a coupon can be identified 410 that is associated with a plurality of merchants. The coupon can have a plurality of coupon conditions and at least one coupon benefit. One or more listings of payment transactions involving at least one of the plurality of merchants can be received 420. One or more listings of non-payment activities can also be received 430. At least one payment transaction between at least one of the plurality of merchants and the customer can be selected 440. The selected payment transaction can be a payment transaction performed using a registered electronic payment instrument. At least one non-payment activity corresponding to the customer can also be selected 450. A plurality of coupon conditions can be matched 460 with one or more of the selected payment transactions and/or one or more non-payment activities. Based on the matching, a transaction can be initiated 470 to provide a coupon benefit to the customer.

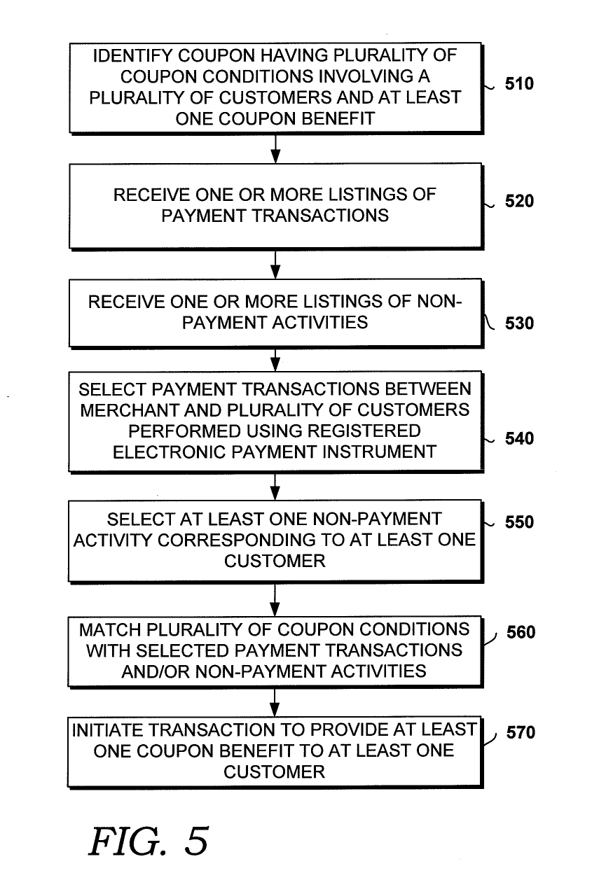

FIG. 5 shows an embodiment related to a method for providing a benefit to a customer after conducting a payment transaction. In FIG. 5, a coupon can be identified 510 involving a plurality of customers. The coupon can have a plurality of coupon conditions and at least one coupon benefit. One or more listings of payment transactions can be received 520. One or more listings of non-payment activities can also be received 530. Payment transactions between a merchant and the plurality of customers can be selected 540. The selected payment transactions can be payment transactions performed using a registered electronic payment instrument. At least one non-payment activity corresponding to at least one of the plurality of customers can also be selected 550. A plurality of coupon conditions can be matched 560 with one or more of the selected payment transactions and/or one or more non-payment activities. Based on the matching, a transaction can be initiated 570 to provide a coupon benefit to at least one customer.

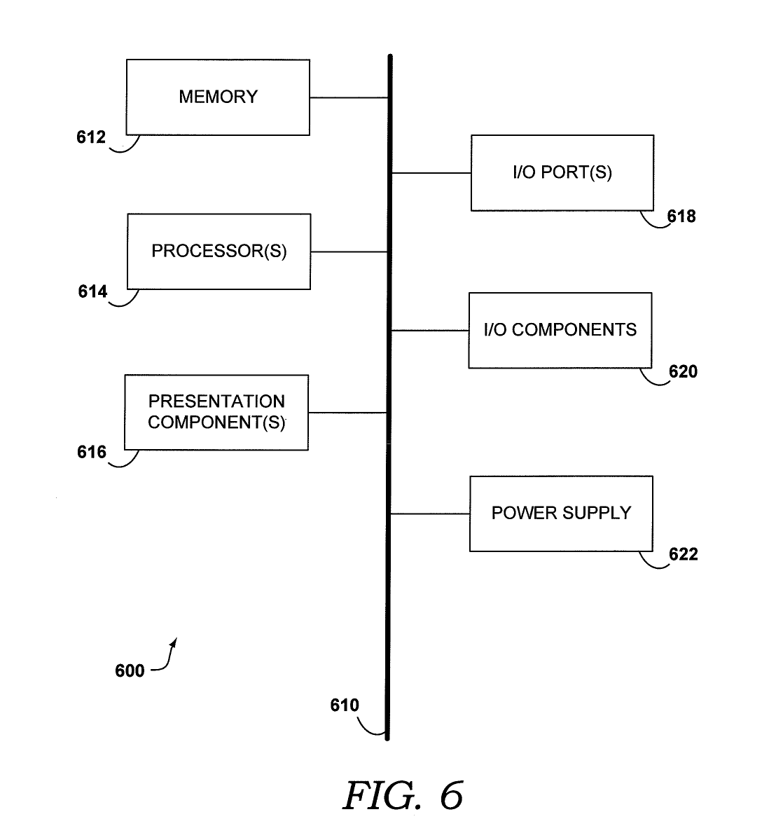

Having briefly described an overview of various embodiments of the invention, an exemplary operating environment suitable for performing the invention is now described. Referring to the drawings in general, and initially to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, and the like. The invention may also be practiced in distributed computing environments where tasks are performed by remote-processing devices that are linked through a communications network.

With continued reference to FIG. 6, computing device 600 includes a bus 610 that directly or indirectly couples the following devices: memory 612, one or more processors 614, one or more presentation components 616, input/output (I/O) ports 618, I/O components 620, and an illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 6 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 6 and reference to “computing device.”

The computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the computing device 600. In an embodiment, the computer storage media can be selected from tangible computer storage media. In another embodiment, the computer storage media can be selected from non-transitory computer storage media.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The memory 612 can include computer-storage media in the form of volatile and/or nonvolatile memory. The memory may be removable, non-removable, or a combination thereof. Exemplary hardware devices include solid-state memory, hard drives, optical-disc drives, etc. The computing device 600 includes one or more processors that read data from various entities such as the memory 612 or the I/O components 620. The presentation component(s) 616 present data indications to a user or other device. Exemplary presentation components include a display device, speaker, printing component, vibrating component, and the like.

The I/O ports 618 can allow the computing device 600 to be logically coupled to other devices including the I/O components 620, some of which may be built in. Illustrative components can include a microphone, joystick, game pad, satellite dish, scanner, printer, wireless device, etc.

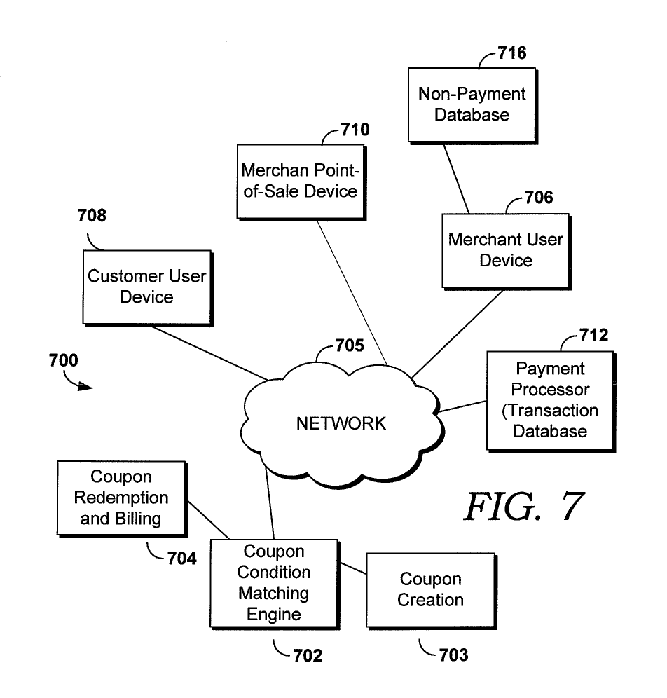

With additional reference to FIG. 7, a block diagram depicting an exemplary network environment 700 suitable for use in embodiments of the invention is described. The environment 700 is but one example of an environment that can be used in embodiments of the invention and may include any number of components in a wide variety of configurations. The description of the environment 700 provided herein is for illustrative purposes and is not intended to limit configurations of environments in which embodiments of the invention can be implemented.

The environment 700 includes a network 705, a merchant user device 706, a non-payment activity database 716, a customer user device 708, and a merchant point of sale device 710. The environment also includes a coupon condition matching engine 702, a coupon creation module 703, a coupon redemption and billing module 704, and a payment processor 712. The network 705 includes any computer network such as, for example and not limitation, the Internet, an intranet, private and public local networks, and wireless data or telephone networks. The merchant user device 706 and customer user device can be any computing device, such as the computing device 600, from which a search query can be provided. For example, the merchant user device 706 and customer user device 708 might be a personal computer, a laptop, a server computer, a wireless phone or device, a personal digital assistant (PDA), or a digital camera, among others. In an embodiment, a plurality of merchant user devices 706 and customer user devices 708, such as thousands or millions of user devices, can be connected to the network 705. The merchant point of sale device 710 can optionally also be a computing device such as device 600, or the merchant point of sale device can be a dedicated device for accepting electronic payment instruments.

The merchant point of sale device 710 can accept electronic payment instrument information and forward it to payment processor 712 for processing of a payment transaction. As shown in FIG. 7, payment processor 712 includes a payment transaction database. A payment transaction database can be used to provide a listing of payment transactions for matching by coupon condition matching engine 702. Optionally, the payment transaction database can be separate from the payment processor 712. Non-payment database 716 can provide a listing of non-payment activities to coupon condition matching engine 702. Non-payment database 716 is shown as being integrated with the merchant user device 706. Alternatively, non-payment database can be a separate entity, such as a separate web site that is not affiliated with the merchant. Coupon creation module 703 and coupon redemption and billing module 704 are shown as being integrated with coupon condition matching engine 702. Alternatively, these components can be separate components that communicate via network 705.

### Additional Examples

In an embodiment, a method is provided for providing a benefit to a customer after conducting a payment transaction. The method includes identifying a coupon having a plurality of coupon conditions. The coupon can be associated with a registered merchant. Optionally, at least one coupon condition can corresponding to a payment transaction condition and at least one coupon condition can correspond to a non-payment activity condition, the coupon having one or more coupon benefits. One or more listings of payment transactions involving the registered merchant can be received. One or more listings of non-payment activities can also be received. At least one payment transaction can be selected that corresponds to a transaction between the registered merchant and a registered customer. The at least one selected transaction being performed using a registered electronic payment instrument. At least one non-payment activity corresponding to the registered customer can also be selected. The plurality of coupon conditions can be matched with one or more selected payment transactions and one or more selected non-payment activities. After matching the plurality of coupon conditions, a transaction can be initiated to provide at least one benefit selected from the one or more coupon benefits to the customer, the at least one benefit being provided to a registered electronic payment instrument used to perform at least one matched selected payment transaction.

In another embodiment, a method is provided for providing a benefit to a customer after conducting a payment transaction. The method can include identifying a coupon associated with a plurality of registered merchants having a plurality of coupon conditions, at least one coupon condition corresponding to a payment transaction condition and at least one coupon condition corresponding to a non-payment activity condition, the coupon conditions corresponding to payment transactions and/or non-payment activities involving a plurality of registered merchants, the coupon having one or more coupon benefits. One or more listings of payment transactions can be received involving at least one of the plurality of registered merchants. One or more listings of non-payment activities can also be received. Payment transactions can be selected corresponding to transactions between the at least one of the plurality of registered merchants and a registered customer, the selected transactions being performed using a registered electronic payment instrument. Non-payment activities can also be selected corresponding to the registered customer. The plurality of coupon conditions can be matched with one or more selected payment transactions and one or more selected non-payment activities. After said matching of the plurality of coupon conditions, a transaction can be initiated to provide at least one benefit selected from the one or more coupon benefits to the customer, the at least one benefit being provided to a registered electronic payment instrument used to perform one of the selected payment transactions

In still another embodiment, a method can be provided for providing a benefit to customers after conducting a payment transaction. The method can include identifying a coupon associated with a registered merchant having a plurality of coupon conditions, at least one coupon condition corresponding to a payment transaction condition and at least one coupon condition corresponding to a non-payment activity condition, the coupon conditions corresponding to payment transactions and/or non-payment activities involving a plurality of registered customers, the coupon having one or more coupon benefits. One or more listings of payment transactions involving the registered merchant can be received. One or more listings of non-payment activities can also be received. Payment transactions can be selected corresponding to transactions between the registered merchant and a plurality of registered customers, the selected transactions being performed using registered electronic payment instruments. At least one non-payment activity can be selected corresponding to at least one registered customer from the plurality of registered customers. The plurality of coupon conditions can be matched with one or more selected payment transactions and one or more selected non-payment activities, the matched selected payment transactions involving the plurality of registered customers. After said matching of the plurality of coupon conditions, a transaction can be initiated to provide at least one benefit selected from the one or more coupon benefits to at least one of the plurality of registered customers, the at least one benefit being provided to a registered electronic payment instrument used to perform one of the selected payment transactions.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

What is claimed is:

1. One or more computer-storage media storing computer-useable instructions that, when executed by a computing device, perform a method for providing a benefit to a customer after conducting a payment transaction, comprising:
identifying a coupon associated with a registered merchant having a plurality of coupon conditions, at least one coupon condition corresponding to a payment transaction condition and at least one coupon condition corresponding to a non-payment activity condition, the coupon having one or more coupon benefits;
receiving one or more listings of payment transactions involving the registered merchant;
receiving one or more listings of non-payment activities;
selecting at least one payment transaction corresponding to a transaction between the registered merchant and a registered customer, the at least one selected transaction being performed using a registered electronic payment instrument;
selecting at least one non-payment activity corresponding to the registered customer;
matching the plurality of coupon conditions with one or more selected payment transactions and one or more selected non-payment activities; and
initiating, after said matching of the plurality of coupon conditions, a transaction to provide at least one benefit selected from the one or more coupon benefits to the customer, the at least one benefit being provided to a registered electronic payment instrument used to perform at least one matched selected payment transaction.

2. The computer-storage media of claim 1, wherein the selected payment transactions have a corresponding date and the selected non-payment activities have a corresponding date, and at least one matching selected non-payment activity has a corresponding date that is later than a corresponding date of the matching one or more selected payment transactions.

3. The computer-storage media of claim 1, wherein the matching one or more selected non-payment activities include an activity of activating the coupon by the registered customer.

4. The computer-storage media of claim 3, wherein the matching one or more selected non-payment activities include at least one additional non-payment activity.

5. The computer-storage media of claim 1, wherein the matching one or more selected non-payment activities include an activity of acquiring a QR code and accessing a corresponding network location associated with the registered merchant.

6. The computer-storage media of claim 1, wherein receiving one or more listings of payment transactions involving a registered merchant further comprises filtering the one or more listings of payment transactions to remove payment transactions that include a non-registered customer.

7. The computer-storage media of claim 1, wherein initiating a transaction to provide at least one benefit selected from the one or more coupon benefits to the customer comprises:
selecting one or more coupon benefits; and
forwarding the transaction information to a servicing party that handles transactions associated with the registered electronic payment instrument.

8. The computer-storage media of claim 1, wherein the non-payment activities corresponding to the registered customer are selected based on at least one of an e-mail address and a registered identification token.

9. The computer-storage media of claim 1, wherein the registered electronic payment instrument has a corresponding physical token.

10. The computer-storage media of claim 1, wherein matching the one or more selected payment transactions with the plurality of coupon conditions comprises:
receiving additional transaction information from the registered merchant;
associating the additional transaction information with at least one selected payment transaction;
matching a coupon condition with the at least one selected payment transaction based on the additional transaction information.

11. The computer-storage media of claim 1, wherein the matched one or more selected payment transactions correspond to payment transactions performed using a plurality of registered electronic payment instruments.

12. The computer-storage media of claim 1, further comprising:
receiving input from the registered merchant to form the coupon having the plurality of coupon conditions;
distributing the coupon having the plurality of coupon conditions.

13. The computer-storage media of claim 1, wherein the coupon is identified based on a date range associated with the coupon.

14. A computer-implemented method for providing a benefit to a customer after conducting a payment transaction, comprising:
identifying a coupon associated with a plurality of registered merchants having a plurality of coupon conditions, at least one coupon condition corresponding to a payment transaction condition and at least one coupon condition corresponding to a non-payment activity condition, the coupon conditions corresponding to payment transactions or non-payment activities involving a plurality of registered merchants, the coupon having one or more coupon benefits;
receiving one or more listings of payment transactions involving at least one of the plurality of registered merchants;
receiving one or more listings of non-payment activities;
selecting payment transactions corresponding to transactions between the at least one of the plurality of registered merchants and a registered customer, the selected transactions being performed using a registered electronic payment instrument;
selecting non-payment activities corresponding to the registered customer;
matching the plurality of coupon conditions with one or more selected payment transactions and one or more selected non-payment activities; and
initiating, after said matching of the plurality of coupon conditions, a transaction to provide at least one benefit selected from the one or more coupon benefits to the customer, the at least one benefit being provided to a registered electronic payment instrument used to perform one of the selected payment transactions.

15. The method of claim 14, wherein the matched one or more selected payment transactions correspond to payment transactions involving more than one of the plurality of merchants.

16. The method of claim 14, wherein the one or more listings of non-payment activities are received from a registered merchant different from at least one merchant involved in the matched one or more selected payment transactions.

17. A computer-implemented method for providing a benefit to customers after conducting a payment transaction, comprising:
identifying a coupon associated with a registered merchant having a plurality of coupon conditions, at least one coupon condition corresponding to a payment transaction condition and at least one coupon condition corresponding to a non-payment activity condition, the coupon conditions corresponding to payment transactions and/or non-payment activities involving a plurality of registered customers, the coupon having one or more coupon benefits;
receiving one or more listings of payment transactions involving the registered merchant;
receiving one or more listings of non-payment activities;
selecting payment transactions corresponding to transactions between the registered merchant and a plurality of registered customers, the selected transactions being performed using registered electronic payment instruments;
selecting at least one non-payment activity corresponding to at least one registered customer from the plurality of registered customers;
matching the plurality of coupon conditions with one or more selected payment transactions and one or more selected non-payment activities, the matched selected payment transactions involving the plurality of registered customers; and
initiating, after said matching of the plurality of coupon conditions, a transaction to provide at least one benefit selected from the one or more coupon benefits to at least one of the plurality of registered customers, the at least one benefit being provided to a registered electronic payment instrument used to perform one of the selected payment transactions.

18. The method of claim 17, wherein a transaction to provide at least one benefit selected from the one or more coupon benefits is initiated for each of the plurality of registered customers.

19. The method of claim 17, wherein the selected non-payment activities correspond to a registered customer that is different from the registered customer that receives the at least one coupon benefit.

20. The method of claim 17, wherein the matched one or more selected non-payment activities include having each of the plurality of registered customers provide a group identification token at a time prior to a time of performing a matching selected payment transaction.
